(19) United States
(12) Patent Application Publication
(10) Pub. No.: US 2014/0207785 A1
(43) Pub. Date: Jul. 24, 2014

(54) Associating VIsuals with Articles

(71) Applicants: Gil Fuchs, Nes Tsiona (IL); Ronen Chen, Modi'in (IL)

(72) Inventors: Gil Fuchs, Nes Tsiona (IL); Ronen Chen, Modi'in (IL)

(73) Assignee: Conduit, Ltd, Ness Ziona, IL (US)

(21) Appl. No.: 13/744,414

(22) Filed: Jan. 18, 2013

(51) Int. Cl. G06F 17/30

(52) U.S. Cl. CPC G06F 17/30424
USPC 707/740; 707/758

(57) ABSTRACT

A method and system for associating a visual graphic with an article in a list of articles, to assist the user in identifying and distinguishing different articles in the list. Associated visuals may be selected from visuals embedded within the article, or may be retrieved from a visual pool via text-matching of article titles and text to text stored with the visuals in the visual pool. Embodiments of the invention provide methods for selecting a unique visual for each title in the list, even when the articles do not contain any illustrating visuals and even when illustrating visuals are duplicated among several different articles.

### FIELD

The present invention relates to automated query systems and, more particularly, to a method for associating visual images with text-based articles for query results.

### BACKGROUND

Automated query systems search archives of text articles according to user queries, and present to the users lists of the titles of articles contained in the archives which are related to the queries. Typically, the article titles serve as links to the articles, so that users may access specific articles by selecting the respective titles from the lists.

According to schemes currently in use, lists of article titles found by automated query systems typically appear as text only. It is desirable to include a visual element, such as an icon, along with each article title in the list, to assist users in intuitively identifying and relating to the articles, and to serve as links to the respective articles. Typically, a visual embedded within an article could serve as an identifying visual for that article. Not all articles, however, have visuals embedded within, nor are visuals necessarily visually-unique among articles which do have embedded visuals, and it would be confusing to use the same visual to identify and link to different articles. It is therefore highly desirable to have a method for associating visually-unique visual elements with all the article titles in a list, regardless of whether or not the respective articles have unique visuals embedded therein. This goal is met by embodiments of the present invention.

### SUMMARY

Embodiments of the present invention provide methods for associating visually-unique visuals with text articles, regardless of whether or not the articles contain embedded visuals, and regardless of whether or not visuals which are embedded are visually-unique.

FIG. 1A illustrates a non-limiting example of a list 500 containing references having associated visuals according to an embodiment of the present invention. List 500 has a topic title 501 followed by a list of related article titles (e.g., a title 505A, 505B, 505C, 505D, and 505E), including links to the respective actual articles. Associated with each article title is a unique visual to assist the user in identifying and accessing the article. In a non-limiting example, title 505B is highlighted, such as by a mouseover. Visual 503B is also highlighted. To access the associated article itself, the user clicks a pointing device when cursor 507 points to the highlighted title or the highlighted visual. FIG. 1 B illustrates a non-limiting example of a layout 551 on the screen of a smart phone 550. Visual links 553A, 553B, 553C, 553D, and 553E have the appearance of icons, and link to their respective associated articles when the user taps a finger on a selected visual link.

The present disclosure teaches how to provide unique visual identifiers and links to articles that originally lack such visuals.

### DEFINITIONS

According to embodiments of the invention, an “article” is a document which is readable by a human and which is stored in machine-readable form that is accessible and retrievable by devices such as computers, smart phones, tablets, and the like. In specific embodiments, an article is principally a text document which may optionally contain one or more visuals. An article that contains at least one visual is herein denoted as an “illustrated article”; and an article that does not contain any visuals is herein denoted as a “text-only article”. In another embodiment of the present invention, an article may also contain multimedia content. In various embodiments of the present invention, an article is considered to be published, and is accessible and retrievable over a network, such as the Internet and/or via cellular data networks.

The term “archive” herein denotes a collection of articles that is accessible and searchable by devices such as computers, smart phones, tablets, and the like. A non-limiting example of an archive is an on-line collection of articles that have been published in a particular publication. Such archives are commonly maintained by publishers of newspapers, magazines, and journals. A search may be performed on one or more archives by providing suitable search criteria that describe the subject matter, contents, and/or metadata (e.g., author, publisher, title, etc.) of the article or articles to be found, and articles that are found by the search may be individually selected for access and/or retrieval by a user. In addition, articles may be referenced in other articles, bibliographies, and/or via network links, and thereby be recommended to users independent of searches. According to embodiments of the invention, the articles of an archive are individually accessible by such devices. In certain embodiments of the invention, an article archive is implemented via a database.

FIG. 2 conceptually illustrates an article archive 350 containing multiple articles 360. An exemplary article 360A contains an optional title 370 and one or more optional headings 375 embedded therein. Article 360A may also contain one or more optional visuals 382, where a visual may have an optional caption 384. Headings and visuals are independent of one another; an article may have neither headings nor visuals, visuals but no headings, headings but no visuals, or both headings and visuals. As noted above, illustrated articles 361 (e.g., articles 361A, 361B, and 361C) each contain one or more visuals, whereas text-only articles 362 (e.g., articles 362A, 362B, and 362C) do not contain visuals.

The noun “visual” herein denotes an image which can be printed and/or displayed on the screen of devices such as computers, smart phones, tablets, and the like. According to various embodiments of the present invention, visuals include, but are not limited to: graphics; drawings and diagrams; maps and charts; icons, logos, and avatars; and photographs. According to an embodiment, a visual is a small, static image such as a “thumbnail” image. According to another embodiment, a visual includes animation clips and video clips. In various embodiments of the invention, visuals are stored in a “visual pool”, which is a repository for holding visuals, each of which has a text descriptor. In certain embodiments of the present invention, a visual pool is implemented via a database.

According to various embodiments of the invention, a pool of visuals is generated and is continually updated for future reference and use. In a related embodiment, a visual pool is compiled for a specific publisher. As new articles become available (e.g., appear on the publisher's website), certain articles might be illustrated with visuals. Such illustrative visuals are collected, and those which are not already in the visual pool are then added to the pool. In some embodiments of the invention, when searching for articles according to search or recommendation procedures, each found article must also have an associated visual for presentation with the article's title lists, such as illustrated in a non-limiting example in FIG. 1A. As noted previously, a relevant and unique (presently unused) visual may already be embedded in the article, and in such cases that visual is chosen as the visual associated with the article. In cases where no relevant and unique visual is embedded in the article, however, the visual pool is accessed to obtain a unique visual for association with the article. Certain embodiments of the invention provide for enlarging and maintaining the visual pool to optimize this facility. In certain embodiments of the present invention, visuals in a visual pool are processed in various ways to improve usability, non-limiting examples of which include: altering the physical size of the visuals (such as for consistency, through scaling and/or cropping); altering the form factor of the visuals (such as for consistency, through scaling and/or cropping); and processing for uniform visual appearance (through brightness, contrast, and gamma correction).

The visual pool is the repository for visuals extracted from articles in the article archive. In related embodiments, visuals are accompanied by associated text extracted from those articles.

Therefore, according to an embodiment of the present invention there is provided a method for associating visuals with articles of an archive, the archive including both text-only articles and illustrated articles having both text and at least one visual, wherein: (a) the articles are categorized into selected articles and unselected articles; (b) the selected articles of the archive include both selected illustrated articles and selected text-only articles; (c) the unselected articles of the archive include both unselected illustrated articles and unselected text-only articles; (d) the method including: (e) for each iterated article of the selected illustrated articles, choosing, by a server, one visual of the visual included in the iterated article, and associating the at least one visual with the iterated article; and (f) for each iterated article of the selected text-only articles, choosing a single visual from the at least one visual included in a plurality of unselected illustrated articles, and associating the single visual with the iterated article.

In addition, according to another embodiment of the present invention there is provided a method for associating visuals with articles of an archive, the archive including illustrated articles having both text and at least one visual, the method including: (a) obtaining a pool of visuals, wherein each visual of the pool has a text descriptor; (b) selecting a plurality of articles from the archive; (c) for each iterated article of the plurality of articles selected from the archive: (d) extracting all visuals from the iterated article; (e) if an extracted visual from the iterated article is not already associated with another selected article, then associate the visual with the iterated article; (f) if there is no extracted visual from the iterated article that is not already associated with another selected article (i.e., all extracted visuals from the iterated article are already associated with other selected articles), then search the pool of visuals for a visual whose text descriptor is a best text match to a title of the iterated article and which is not already associated with another selected article; (g) if a visual is found in the visual pool whose text descriptor is a best text match to the title of the iterated article and which is not already associated with another selected article, then associate the found visual with the iterated article; and (h) if no visual is found in the visual pool whose text descriptor is a best text match to the title of the iterated article and which is not already associated with another selected article, then remove the iterated article from the plurality of selected articles.

### BRIEF DESCRIPTION OF THE DRAWINGS

The present invention will be more fully understood from the following detailed description of the embodiments thereof, taken together with the drawings in which:

FIG. 1A illustrates a list of article titles with associated visuals for presentation to a user according to an embodiment of the present invention.

FIG. 1B illustrates a layout of article visual links for presentation to a user according to another embodiment of the present invention.

FIG. 2 conceptually illustrates the components of an article and an article archive.

FIG. 3 conceptually illustrates the components of a visual and a visual pool according to an embodiment of the present invention.

FIG. 4 illustrates a method for compiling a visual pool according to an embodiment of the present invention.

FIG. 5 illustrates a method for associating a visual with a listed article according to an embodiment of the present invention.

FIG. 6 conceptually illustrates a system according to an embodiment of the present invention.

### DETAILED DESCRIPTION

The principles and operation of embodiments of the present invention may be understood with reference to the drawings and the accompanying description.

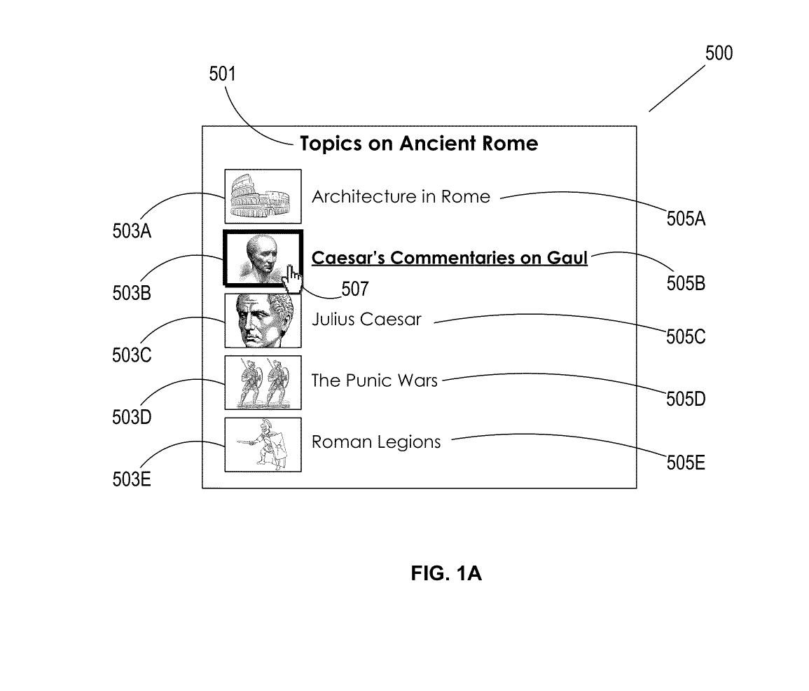

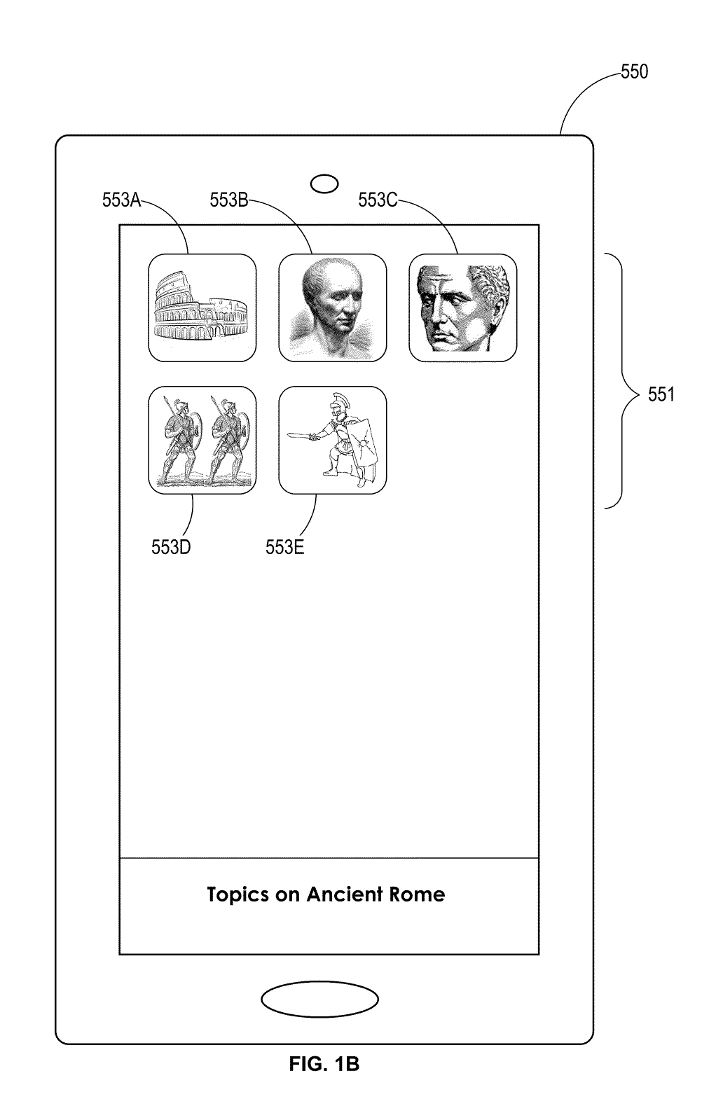

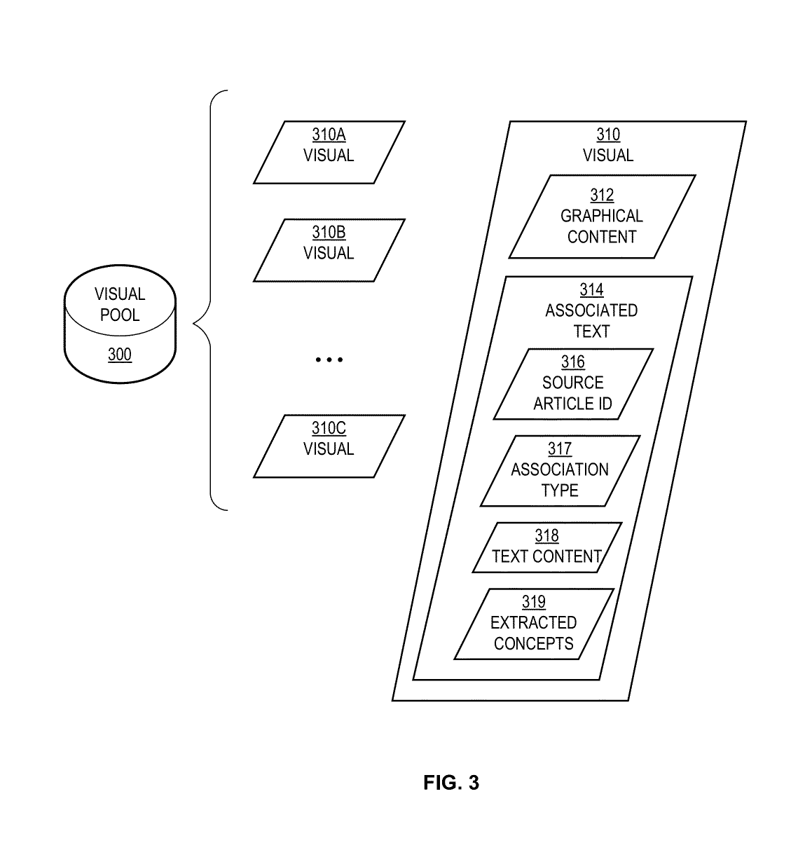

FIG. 3 conceptually illustrates the components of a visual 310 and a visual pool 300 according to an embodiment of the present invention. Visual pool 300 contains multiple visuals, including visuals 310A, 310B, and 310C as illustrated in FIG. 3, and serves as a repository of visuals for association with article titles in a list (as shown in FIG. 1A) or as article links in a layout (as shown in FIG. 1B). Visual 310 contains: graphical content 312, which includes data formatted for display of the visible visual; and an associated text data structure 314, which is metadata relating to the visual. In some embodiments, graphical content 312 is a still picture in a standard format, non-limiting examples of which include “jpeg” and “gif” format. In other embodiments, graphical content 312 is a graphical illustration, an animation, or a multi-media item with a visual component. According to an embodiment of the invention, an article can have multiple embedded visuals. In additional embodiments, a link to a related article within a currently-presented article is displayed with an associated visual.

Each visual in pool 300 is associated with some text, which typically describes the visible content and appearance of the visual. According to various embodiments of the present invention, associating text with visuals is essential in order to facilitate conducting text-based searches for visuals.

In some embodiments of the invention, associated text 314 includes an article identifier 316 which identifies the article in which visual 310 was originally embedded. An association type 317 indicates the nature of the association of the text with graphical content 312, including but not limited to: an article title; a picture caption; a nearby heading (such as a heading for a section of the article in which the visual appears); or other type of association. Text content 318 is the character string data of the associated text itself. A non-limiting example of text content is “Julius Caesar (100 BCE-44 BCE), Roman statesman and general”. Extracted concepts 319 include post-processing on the text. Non-limiting examples of extracted concepts for this content include: “Julius Caesar”, “Julius Caesar 01”; “Julius Caesar, ¾ bust”, “Roman statesman”, “Roman general”, and the like.

In a related embodiment of the invention, there are multiple associated text data structures 314 indicating that visual 310 is embedded in more than one different article.

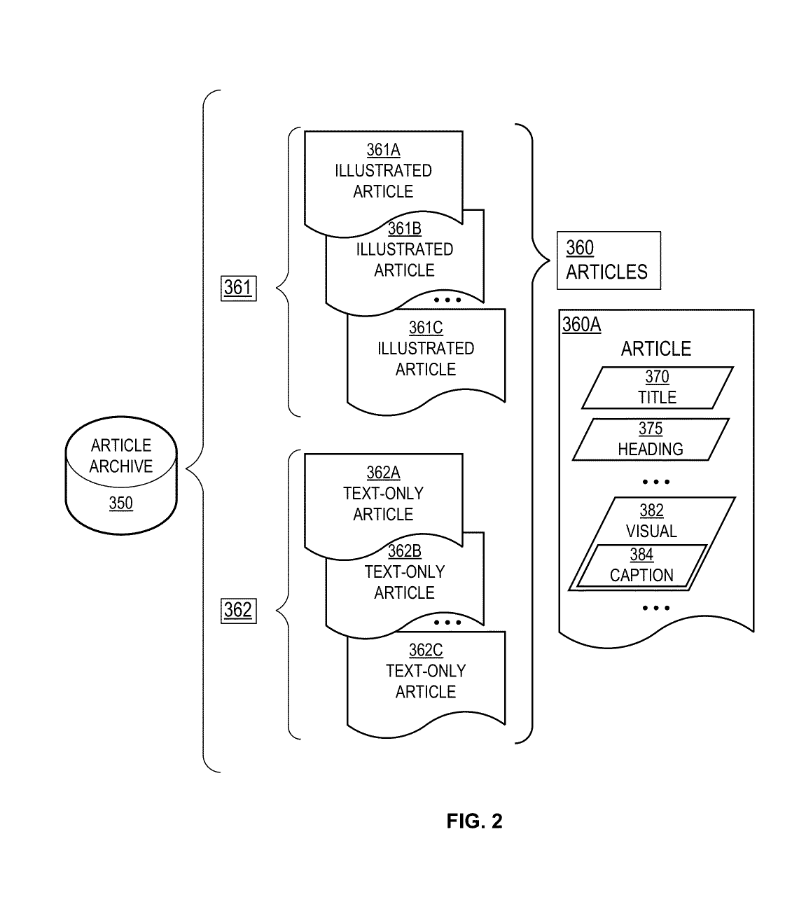

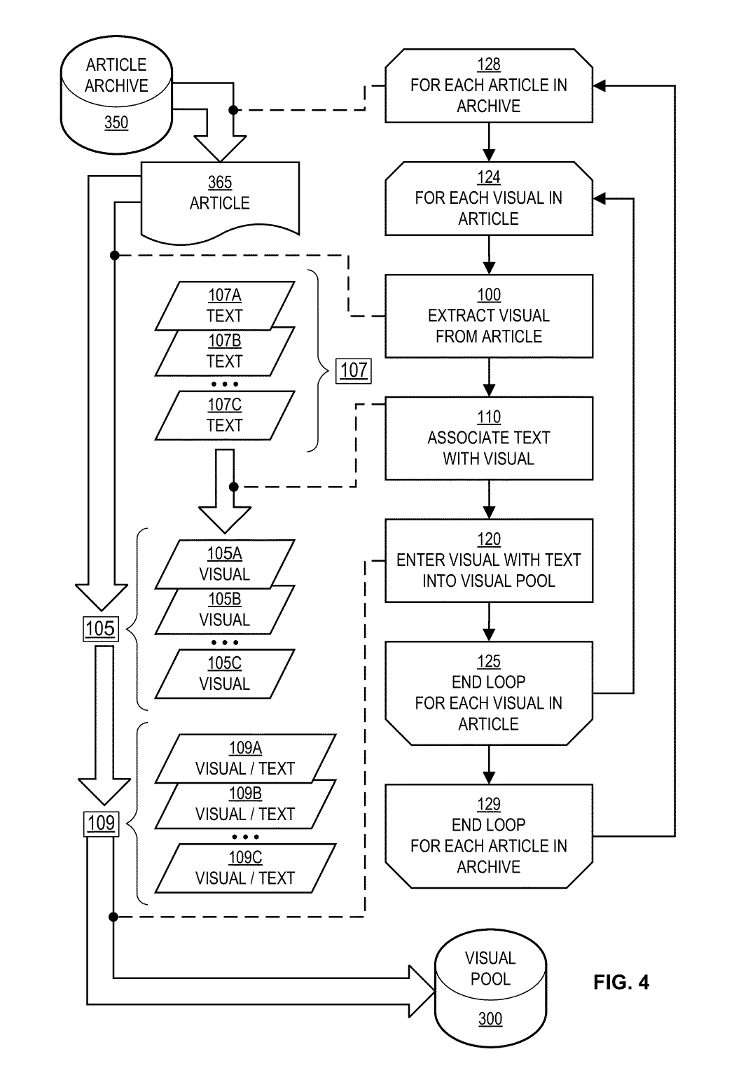

FIG. 4 illustrates a method for compiling visual pool 300 according to an embodiment of the present invention. A step 128 begins a loop that iterates on each article 365 of archive 350 (also see FIG. 2). A step 124 begins a loop that iterates on each visual on the article being iterated in the loop beginning at step 128. A step 100 extracts an iterated visual 105 from the iterated article (e.g., visual 105A, visual 105B, visual 105C, etc.). A step 110 associates text 107 with visual 105 (e.g., text 107A with visual 105A, text 107B with visual 105B, text 107C with visual 105C, etc.), to form combined visual with associated text 109 (e.g., visual/text 109A, visual/text 109B, visual/text 109C, etc.). Then, in a step 120 visual with text 109 is entered into visual pool 300 for later access and retrieval. A loop end step 125 returns to step 124 for the next visual of currently-iterated article 365, and if there are no more visuals in currently-iterated article 365, a loop end step 129 is executed, which returns to step 128 for the next iterated article 365 of archive 350, and if there are no more articles in archive 350, the method concludes. According to another embodiment of the invention, when a new article is entered into article archive 350, loop 124-125 is executed for the new article as a continuous and on-going process. When there is a continual flow of new articles into article archive 350, visual pool 300 continues to grow.

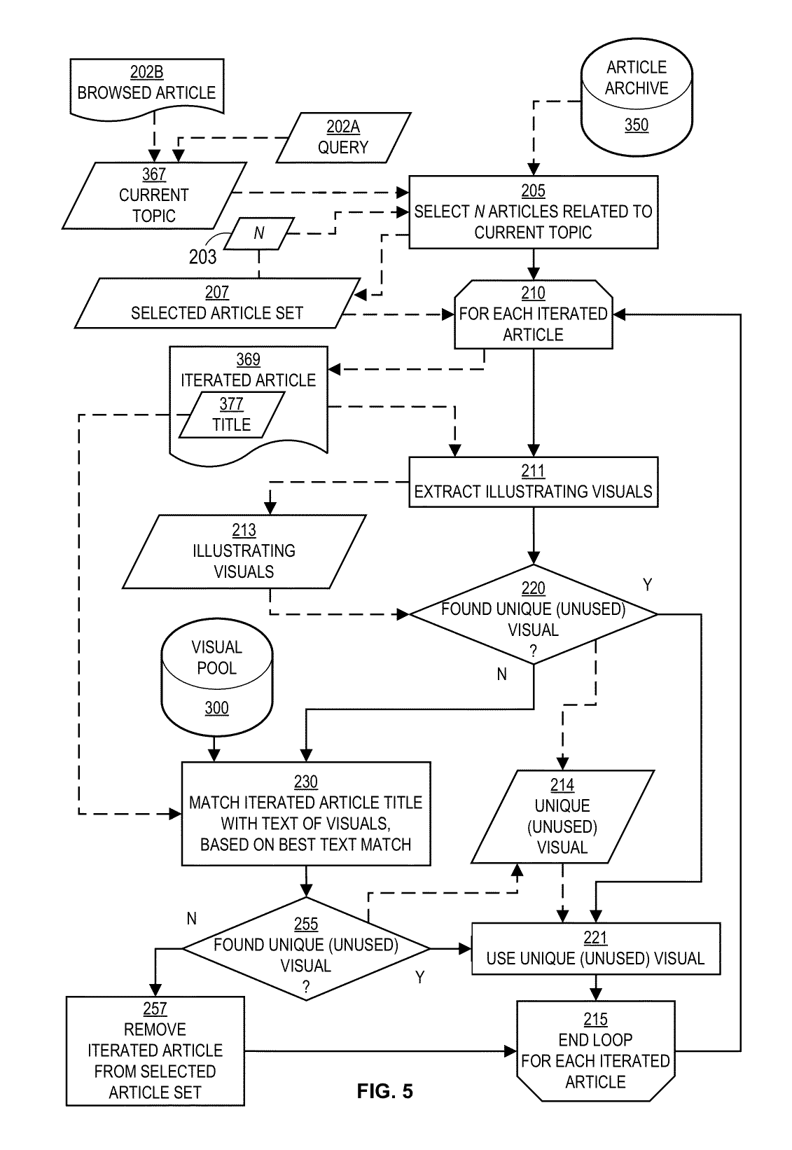

FIG. 5 illustrates a method for associating unique visuals with articles relating to a current topic 367 according to an embodiment of the present invention. Current topic 367 is determined by the user in one of two modes. In one mode, the user submits a text query 202A having search criteria to a search engine operating over article archive 350, and the user's query and search criteria implicitly establish current topic 367 as being the subject matter of the results retrieved from article archive 350 by the search engine according to the search criteria of query 202A. In a non-limiting example, it is possible to use the search terms as provided by the user. In the other mode, the user is reading a browsed article 202B whose subject matter establishes current topic 367, and an application (a non-limiting example of which is a search engine) retrieves a set of topics related to browsed article 202B. According to various embodiments of the invention, the application selects related articles on the basis of factors including, but not limited to: recentness, relevance, popularity, and accessibility.

According to various embodiments of the invention a unique visual is to be associated with each article in a list of articles for presentation to the user. In a step 205 a set 207 of N articles related to listed article 367 are selected from article archive 350. A predetermined number N 203 is a parameter for the size of set 207. Depending on the mode, as discussed above, the articles of set 205 may be selected from article archive 350 by well-known search methodologies according to criteria of query 202A; or, the articles of set 205 may be selected from article archive 350 by well-known recommendation methodologies according to browsed article 202B. Non-limiting examples of suitable recommendation methodologies include: “similar context”; “popular for a particular group”; and “known to be of interest to this particular user”. Embodiments of the present invention do not depend or rely on the specific methodology or mechanisms employed, so long as the articles of article archive 350 are categorized into selected articles (those in set 207) and unselected articles (those not in set 207). Articles in article archive 350 in general include both illustrated articles (having at least one visual) and text-only articles, and selected articles in set 207 in general also include both illustrated articles and text-only articles.

A step 210 begins a loop which iterates over the articles of set 207, and in a step 211 the visuals (if any) of iterated article 369 are extracted into a set 213 of extracted illustrating visuals. A step 215 represents the end of the code of the loop begun at step 210; if there are further articles in set 207 to iterate, step 211 is repeated as necessary. Otherwise, if there are no more articles in set 207 to iterate, the loop ends with no further iterations. Inside each of the loop cycles 210-215 there is a decision point 220. According to an embodiment of the invention, a set 213 contains all images extracted from iterated article 369. At decision point 220, if set 213 contains a unique visual 214, then in a step 221 unique visual 214 is used as the visual associated with iterated article 369. According to various embodiments of the invention, a visual is “unique” (or “unused”) if that visual is not already associated with another article in set 207. If, however, decision point 220 decides that no unique visual was found in illustrating visuals set 213, a step 230 attempts to find a visual in visual pool 300 whose text descriptor is a best text match to a title 377 of iterated article 369. If matching step 230 finds a unique (unused) visual, then a decision point 255 sets the found visual as visual 214 and then executes step 221. If, however, matching step 230 fails to find a unique visual for iterated article 369 from visual pool 300, then decision point 255 executes a step 257 to remove iterated article 369 from set 207. Although iterated article 369 is removed from set 207, iterated article 369 may remain in article archive 350 for possible future selection. According to a related embodiment of the invention, an article removed from set 207 is replaced with another article from article archive 350, in order to maintain a total of N articles in set 207.

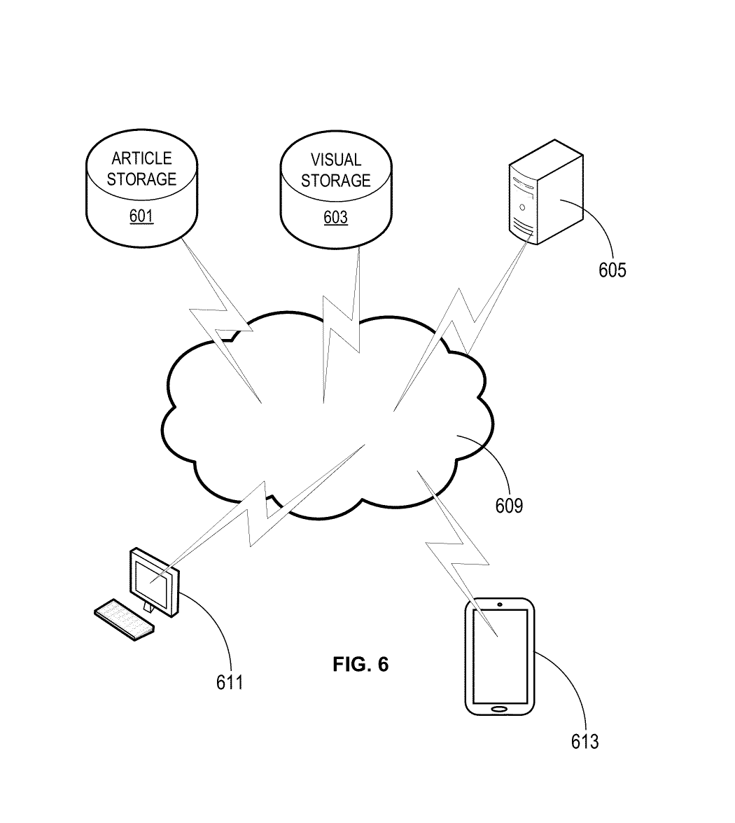

FIG. 6 conceptually illustrates a system according to an embodiment of the present invention. A server 605 accesses an article storage device 601, which maintains article archive 350 (FIG. 2), and a visual storage device 603, which maintains visual pool 300 (FIG. 3). Server 605 performs any of the foregoing methods, and variants thereof, to provide lists of article titles with associated visuals (as illustrated in FIG. 1A), and arrangements of visual links to articles (as illustrated in FIG. 1B) to user devices such as a computer 611 and a smart phone 613.

Embodiments described above provide visuals for articles that are unique for each article in a set of selected visuals, in cases where an article may have no associated visual, or may have a visual that has already been associated with another article of the set. Additional embodiments of the invention handle the case where an article already has a unique visual, but the visual is unsatisfactory for a specific reason. In a non-limiting example, a unique visual embedded in an article may be too small to be used effectively. For instance, the number of pixels in the visual may be below a specified threshold. In such a case, the unsatisfactory visual is ignored.

While the invention has been described with respect to a limited number of embodiments, it will be appreciated that many variations, modifications and other applications of the invention may be made.

1. A method for associating visuals with articles of an archive, the archive including both text-only articles and illustrated articles having both text and at least one visual, wherein:
the articles are categorized into selected articles and unselected articles;
the selected articles of the archive include both selected illustrated articles and selected text-only articles;
the unselected articles of the archive include both unselected illustrated articles and unselected text-only articles;
the method comprising:
for each iterated article of the selected illustrated articles, choosing, by a server, one visual of the at least one visual included in the iterated article, and associating the at least one visual with the iterated article; and
for each iterated article of the selected text-only articles, choosing a single visual from the at least one visual included in a plurality of unselected illustrated articles, and associating the single visual with the iterated article.

2. The method of claim 1, wherein the selected articles are selected by a search process according to search criteria received from a user.

3. The method of claim 1, wherein choosing a single visual comprises:
assigning a text identifier to the at least one visual included in the unselected illustrated articles, wherein the assigning is based on at least one of:
a picture caption of the at least one visual,
a section headline of the article, or
a title of the article; and
identifying the single visual by a textual match between:
the text of the each article of the selected text-only articles, and
the text identifiers assigned to all visuals that have not yet been associated with an article of the selected text-only articles.

4. The method of claim 1 further comprising: upon a failure of the choosing a single visual, deselecting a previously selected illustrating visual and including the article among the selected text-only articles and repeating the method of claim 1 to select a different visual.

5. The method of claim 1, further comprising: upon a failure of the choosing a single visual, deselecting the selected text-only article and including the article among the unselected text-only articles.

6. A method for associating visuals with articles of an archive, the archive including illustrated articles having both text and at least one visual, the method comprising:
obtaining a pool of visuals, wherein each visual of the pool has a text descriptor;
selecting a plurality of articles from the archive;
for each iterated article of the plurality of articles selected from the archive:
extracting all visuals from the iterated article;
if an extracted visual from the iterated article is not already associated with another selected article, then associate the visual with the iterated article;
if there is no extracted visual from the iterated article that is not already associated with another selected article, then search the pool of visuals for a visual whose text descriptor is a best text match to a title of the iterated article and which is not already associated with another selected article;
if a visual is found in the visual pool whose text descriptor is a best text match to the title of the iterated article and which is not already associated with another selected article, then associate the found visual with the iterated article; and
if no visual is found in the visual pool whose text descriptor is a best text match to the title of the iterated article and which is not already associated with another selected article, then remove the iterated article from the plurality of selected articles.

7. A server having access to a plurality of articles stored in an article storage device and access to a plurality of visuals stored in a visual storage device, wherein the server is arranged to:
select a set of articles from the archive;
for each iterated article of the set of articles selected from the archive:
extract all visuals from the iterated article;
if an extracted visual from the iterated article is not already associated with another selected article, to associate the visual with the iterated article;
if no extracted visual from the iterated article is not already associated with another selected article, then search the pool of visuals for a visual whose text descriptor is a best text match to a title of the iterated article and which is not already associated with another selected article;
if a visual is found in the visual pool whose text descriptor is a best text match to the title of the iterated article and which is not already associated with another selected article, then associate the found visual with the iterated article; and
if no visual is found in the visual pool whose text descriptor is a best text match to the title of the iterated article and which is not already associated with another selected article, then remove the iterated article from the set of selected articles.
